(19) United States
(12) Patent Application Publication
(10) Pub. No.: US 2024/0198586 A1
(43) Pub. Date: Jun. 20, 2024

(54) METHOD AND APPARATUS FOR CHEMICAL SMOOTHING

(71) Applicant: Rösler Holding GmbH, Bad Staffelstein (DE)

(72) Inventors: Moritz BECK, Bad Staffelstein (DE); Lukas HARTAN, Kronach (DE); Till MERKEL, Neu-Ulm (DE); Florian MÜLLER, Ebern (DE); Paul SIMON, Bischofsheim i. d. Rhön (DE)

(21) Appl. No.: 18/244,339

(22) Filed: Sep. 11, 2023

(30) Foreign Application Priority Data
Sep. 20, 2022 (DE) 102022124098.3

(51) Int. Cl. B29C 64/188; B29C 71/00

(52) U.S. Cl. CPC B29C 64/188; B29C 71/0009

(57) ABSTRACT

In a method for the chemical smoothing of components composed of plastic, said components are immersed at atmospheric pressure in a pre-temperature- controlled process liquid composed of glycol.

The present invention relates to a method and an apparatus for the chemical smoothing of components composed of a polymer material that are in particular manufactured in an additive manufacturing process.

A wide variety of methods and apparatus are known in the prior art for the smoothing of plastic surfaces. For example, process fluids can be injected into a processing space, where they at least partly evaporate and thereby act on the surfaces of the products either as liquids or as vapor. Some methods use a negative pressure chamber, wherein excess pressure methods are also known, however. The process liquids used are often harmful to health, environmentally relevant, corrosive or highly flammable in this respect.

It is the object of the present invention to provide a method and an apparatus for the chemical smoothing of plastic components by which an efficient and high-quality smoothing can be achieved in a short time with a low apparatus effort, wherein the burden on the environment is minimized.

This object is satisfied by the features of the independent claims. Advantageous embodiments are described in the description, in the drawing, and in the dependent claims.

In a method in accordance with the invention for chemical smoothing, a pre-temperature-controlled process liquid is provided and components made of a polymer material are completely wetted with process liquid, in particular immersed therein, over a time period. Here, immersion is understood to mean that the components are completely surrounded by process liquid. The components can therefore also be inserted into a container that is subsequently filled or flooded with process liquid so that the components are completely located in the process fluid. After the components have been immersed in the process liquid over a time period, they are removed from the process liquid.

However, the process liquid can be applied to the components not only by immersion, but alternatively or additionally also by spraying. Sufficient contact times can be achieved during a spraying on, depending on the viscosity and the spray duration. At the same time, a spray treatment can also serve to smooth fine structures and peaks less than by an immersion since the process liquid can run off more easily from such contours.

In accordance with the invention, the aforementioned method is performed at atmospheric pressure and at least 50% by volume of the process liquid consists of glycol or a mixture of a plurality of glycols. Indeed, it has been found that a process liquid consisting substantially of glycol or a glycol mixture is very effective for smoothing components, in particular components that are manufactured in additive manufacturing processes. Glycols are also classified as non-corrosive and as not readily flammable so that the apparatus effort can be kept simple. Since the method operates at atmospheric pressure, no vacuum chambers, pressure chambers or the like are required and low-cost components such as pumps, valves and the like can be used. In accordance with the invention, atmospheric pressure is understood as the environmental pressure here, wherein a slight, in particular temporary, exceeding or falling below of the environmental pressure, for example by 5, 10, 20, 30, 40 or 50 mbar, is likewise considered to be in accordance with the invention.

According to an advantageous embodiment, the process liquid can be pre-temperature-controlled to a temperature of approximately 150° C. to 190° C., in particular to a temperature of approximately 160° C. to 180° C. Process temperatures in this range have been shown to be particularly effective. Due to the increased temperature, the movability of the polymer chains in the usually semi-crystalline polymer material increases. The molecules of the process liquids interpose themselves between the polymer chains in the region near the surface and further mobilize said polymer chains. It is energetically advantageous for the movable polymer chains to reduce their surface size, whereby the smoothing effect results. Here, the smoothing effect of the process liquid on the component surface is decisively determined by the temperature and the physical-chemical interaction.

According to a further advantageous embodiment, the components can be treated with process liquid over a time period of less than 15 or 20 minutes, in particular of less than 10 minutes. Indeed, tests have shown that a very effective, high-quality smoothing can already be achieved when the components have been in contact with process liquid for only a few minutes.

According to a further advantageous embodiment, the components can be immersed multiple times and removed from the process liquid again. After the process liquid has been pre-temperature-controlled, a preheating of the parts can hereby also take place before the actual smoothing process begins. Alternatively or additionally, it is also possible to preheat the components using the vapor that develops above the process liquid.

According to the present invention, at least 50% by volume of the process liquid consists of a glycol or a mixture of a plurality of glycols. The type of glycol can vary here. In accordance with an advantageous embodiment, at least one glycol or the glycol corresponds to the following formula (I):

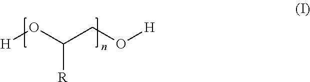

In formula (I), n is a whole number in a range from 1 to 60, in particular in a range from 1 to 15, and R is either a hydrogen atom or a monovalent organic residue, preferably a hydrocarbon residue, in particular having 1 to 15 carbon atoms. R is preferably a saturated hydrocarbon group having 1 to 5 carbon atoms. In accordance with a particularly preferred embodiment, R is a hydrogen atom or a methyl group, in particular a hydrogen atom. The terminal hydrogen atoms shown in formula (I) can optionally be substituted by other terminal groups.

In accordance with an even more advantageous embodiment, at least one glycol of the process liquid is an ethylene glycol, a propylene glycol or a dimeric, trimeric, tetrameric or pentameric of ethylene glycol or propylene glycol, in particular triethylene glycol.

According to a further advantageous embodiment, the process liquid can comprise a mixture of at least two glycols, wherein the mixture can in particular consist of exactly two glycols. Mixtures of triethylene glycol, i.e. a trimeric of ethylene glycol, and polyethylene glycol, which have a low vapor pressure at process temperatures in the range from 160 to 190° C. and can thereby be used safely with only a small apparatus effort, have proved to be advantageous in this respect.

A mixture of two glycols can be present in a mixing ratio of 5:1 to 1:5, in particular in a mixing ratio of 1:1. By suitably adjusting the mixing ratio, the process liquid can be optimized for different smoothing tasks.

Furthermore, it can be advantageous if the process liquid includes salts and/or mineral acids in a small proportion, for example a proportion of less than 2% by volume. For example, an addition of mineral acid, such as sulfuric acid, in a proportion of less than 1% by volume can be advantageous to optimize the smoothing process.

In accordance with the invention, at least 50% by volume of the process liquid consists of glycol or a mixture of a plurality of glycols. The content of the glycol or of the mixture of a plurality of glycols in the process liquid can be adapted in dependence on the polymer material to be treated and, according to a preferred embodiment, amounts to at least 75% by volume, preferably at least 90% by volume, even more preferably at least 98% by volume. If a portion of the process liquid does not consist of glycols, this portion preferably has a boiling point that is above the process temperature, in particular above a temperature to which the process liquid is optionally pre-temperature-controlled, i.e. a boiling point above a temperature of approximately 150° C. to 190° C., in particular a boiling point above a temperature of approximately 160° C. to 180° C. Suitable examples of this portion are oils based on hydrocarbons or organosilicon compounds, polymeric compounds, alkanediols and other higher-order alcohols that have 3 to 10 carbon atoms, in particular 3 to 7 carbon atoms, and are not glycols, as well as oligomers of such alkanediols having 2 to 10 repeating units, and mixtures of these examples, or also long-chain monovalent alcohols such as octanol.

According to a further advantageous embodiment, the process liquid can comprise a dissolved or dispersed dye. Since the process liquid also penetrates the surface of the components during the smoothing process, such dyes can likewise penetrate the component surface and react there and thereby color the plastic surface.

The polymer material from which a component that is smoothed by the method in accordance with the invention is made is not further limited. However, the polymer material is preferably based on a polymer that is based on at least one monomer having at least one heteroatom, in particular oxygen, nitrogen or sulfur. Due to the heteroatom, an interaction between the polymer material and molecules of the process liquid, in particular the glycol, can occur so that these molecules can enter the region near the surface between the polymer chains and can mobilize them. As described above, a smoothing effect is hereby produced since the mobilized polymer chains assume an energetically favorable state.

The polymer material is preferably based on polyamide, polyester or polyether ether ketone. In accordance with an advantageous further development, the polymer material is a polyamide that is selected from the group consisting of PA 6, PA 11, PA 12, PA 6.6, PA 6.9, PA 6.12, PA 4.6, PA 12.12, in particular from the group consisting of PA 6, PA 11, PA 12. In a further advantageous further development, the polymer material is a polyester that is selected from the group consisting of PBT, PET, PLA, PTT, PEN, PC, PEC and PAR, in particular from the group consisting of PBT, PET and PLA. A particularly preferred polyester is PBT. The material can also be based on polyurethanes or on thermoplastic polyurethanes.

As already mentioned above, the temperature of the component during the smoothing process is an important process variable for controlling the process. According to a further advantageous embodiment, the temperature of a component can therefore in particular be continuously detected during the method and can be used as a control parameter. Due to an accurate detection of the component temperature, the component temperature can, for example, be detected within a temperature window in which a smoothing effect begins to develop. Based on this temperature, the temperature of the process liquid, the dwell time of the components in the process liquid and/or another process parameter can then be controlled.

To detect the component temperature, it can be advantageous if a temperature sensor is attached to one of the components before the immersion. For example, the temperature sensor can be attached to a surface of the component that is not a visible surface during subsequent use. It is also possible to fasten a temperature sensor to a building panel that consists of the same material as the components. Finally, it is also possible to use a component within a batch as a “sacrificial component”, wherein the temperature sensor can then, for example, be inserted into a bore of the sacrificial component to detect the surface temperature of the component and in particular also the temperature development for different insertion depths. Such a sacrificial component can have the same geometry as the other components to be smoothed and it can in particular also be used for a plurality of batches.

Alternatively, a temperature sensor can be attached near a component, said temperature sensor having a temperature probe and a sleeve having known properties such as material, thickness, or thermal conductivity. Depending on the environmental temperature of the sensor and the dwelling time in the liquid phase or in the gas phase of the process liquid, the measured value determined by the sensor changes. By applying suitable correlations (empirical determination, theoretical calculation via transient heat conduction), this measured value can then be converted into a current component temperature. A consideration of the material properties of the component also enables the calculation of temperature profiles within the component so that temperature developments can also be determined in dependence on the component geometry via a measurement with such a sensor.

According to a further advantageous embodiment, the immersion in the process liquid can take place in a processing container that can be closed in an airtight manner by a cover. Vapors, which could be deposited in the environment, can hereby be prevented from escaping via the free fluid surface when the process liquid is heated. The resulting vapors can then be led off via a filter, for example.

According to a further advantageous embodiment, the process liquid can be pre-temperature-controlled in a temperature control container and can be transferred from there into a processing container in which the components are immersed in the process liquid. The temperature control container in this respect serves as a storage container in which the process liquid can be heated or cooled very effectively.

According to a further advantageous embodiment, the process liquid can be conducted in a circuit between the temperature control container and the processing container. In this way, it is ensured that no significant temperature gradient is present within the process liquid and that desired temperature changes quickly affect the entire process liquid.

According to a further advantageous embodiment variant, the components can be cooled in the processing container after the removal of the process liquid. Thus, it is, for example, possible to guide environmental air through the space above the fluid surface within the processing container in order thereby to cool the components. Since a smoothing process does not start gradually but rather abruptly, it can be initiated or terminated with very small temperature changes. A cooling of the process liquid by a cooler in a feed line or by introducing very cold media (e.g. small quantities of liquid nitrogen or dry ice) can also produce the desired effect here, i.e. the rapid cooling of the liquid and thus the shifting of the temperature out of the process window.

According to a further aspect, the present invention relates to an apparatus for performing a method of the above kind, comprising a processing container and a temperature control container for the temperature control of the process liquid, wherein the two containers are connected to one another via a liquid circuit in which a pump is located. With such an apparatus, the process liquid can be effectively temperature controlled without significant temperature gradients occurring within the process liquid. According to the invention, it is also possible to provide a cooling device, for example a cooling coil for cooling. In this way, a cooling/freezing of the component surface with liquid can take place. The cold liquid could be applied by spraying. Due to a combined application of dipping, spraying and a gas phase, particularly good results can be achieved.

According to a further advantageous embodiment, the processing container can be closable in an airtight manner by a cover and can be provided with a gas outlet.

In this way, vapors within the processing container can be intentionally led off and filtered, for example.

According to a further advantageous embodiment, the gas outlet can open into a cooling device that is in communication with the atmosphere. Due to such a cooling device, exiting vapors can be prevented from undesirably heating the environment. At the same time, the cooling device can be provided with a condenser that condenses process liquid so that a gas exiting from the cooling device is free of process vapor.

According to a further advantageous embodiment, the cover of the processing container can have a holder for components to be smoothed. This represents a simple solution from an apparatus aspect since the components to be smoothed can simultaneously be introduced into the processing container by lowering or closing the cover.

According to a further advantageous embodiment, at least one lifting device can be provided by which the cover can be moved relative to the processing container and/or the holder can be moved relative to the cover. With such a lifting device, which can for example comprise one or two actuating drives, the cover can be lowered onto the processing container, on the one hand. On the other hand, when the cover is closed, a lowering of the components to be smoothed can take place so that they can be immersed in the process liquid or surrounded by process liquid by filling it into the processing container.

The present invention will be described in the following purely by way of example with reference to an advantageous embodiment and to the enclosed drawing.

The single FIGURE shows an exemplary embodiment of an apparatus for smoothing plastic components.

The apparatus shown in the FIGURE comprises a processing container 10 that can be closed in an airtight manner by a cover 12. Below the processing container 10 and next to it, a temperature control container 14, which is in particular insulated, can be provided in which process liquid P can be received. In this respect, the two containers 10 and 14 are connected to one another via a liquid circuit that comprises a first pipeline 16 and a second pipeline 18 that are in particular insulated. Here, the first pipeline 16 connects a base region of the temperature control container 14 to a base region of the processing container 10. The second pipeline 18, which is arranged approximately diametrically to the first pipeline 16 at the lower side of the processing container 10, connects the lower side of the processing container 10 to an inlet 20 of the temperature control container 14.

Furthermore, a pump 22 is located in the pipeline 16 between the temperature control container 14 and the processing container 10, by which pump 22 the process liquid P can be pumped in a circuit between the temperature control container 14 and the processing container 10. To (at least partly) flood the processing container 10 with process liquid P, a valve 24 is provided in the pipeline 18 and prevents a backflow of process liquid from the processing container 10 into the temperature control container 14 when the valve is closed. A temperature probe 24 is arranged in front of the valve 24 in the direction of flow and is connected to a control (not shown). This control also controls a heating device 27 provided within the temperature control container 14 so that the process liquid P can be pre-temperature-controlled to a desired temperature within the temperature control container 14. A cooling of the process liquid can also take place by a cooling device, not shown, in the temperature control container 14 and/or in the pipelines 16 or 18. A temperature control can also take place in the processing container 10, for example a wall temperature control (cold, hot), e.g. double-walled (e.g. thermo sheet) or with a welded-on pipeline. Within the temperature control container 14, a filling level sensor 28 is provided in its base region and a further temperature probe 30 is provided approximately at its center. Furthermore, a filter 31 is located within the temperature control container 14 below the inlet 20, by which filter 31 particles or solids—e.g. a powder buildup from the manufacturing process—are filtered out. Finally, the reference numeral 32 denotes a maintenance flap by which the temperature control container 14 can be closed in an airtight manner.

The base of the temperature control container 14 is inclined and is formed as a sloping base 34, wherein an outlet 38, which can be blocked by a valve 36, is located at the lowest point of the sloping base 34 to completely drain the process liquid P if required.

As the FIGURE furthermore shows, the processing container 10 is likewise provided with a sloping base 40 at whose lowest point the pipeline 18 is arranged. As the enlarged representation in the FIGURE clearly shows, the pipeline 18 within the processing container 10 merges into a vertically oriented pipe socket 42 at whose lower end, i.e. directly above the sloping base 40, an aperture 44 is provided to completely drain the process liquid P from the processing container 10, if required. In normal operation, the conveying quantity of the pump 22 is selected to be greater than the draining quantity that can flow through the aperture 44 so that, in operation of the pump 22, the processing container 10 is filled with process liquid P up to the filling level F1 shown in the FIGURE when the valve 24 is open. By closing the valve 24, the processing container 10 can be filled or flooded with process liquid P during operation of the pump 22 until the process liquid P within the processing container 10 reaches a filling level F2. Above the filling level F2, an overflow line 46 opens into the interior of the processing container 10 and is guided at its lower end into the inlet 20 of the temperature control container 14. The overflow line 46 can be closed by a valve 48 so that vapor and/or liquid can no longer enter the temperature control container 14 from the processing container 10. A temperature probe 33 is arranged in the processing container 10 beneath the overflow line 46 in the region of the filling level F2.

The FIGURE further shows that a fresh air inlet 50, which is closable by a valve 52, is provided in the upper region of the processing container 10. A gas outlet 54 is located in the upper region of the processing container 10 approximately diametrically opposed to the fresh air inlet 50 and is in communication with an air outlet 58, which is open to the atmosphere, via a gas cooler 56. The interior of the processing container 10 is therefore in communication with the surrounding atmosphere at all times.

The gas cooler 56 can, for example, comprise a cooling coil 60 that is flowed through by cooling fluid, whereby vapor exiting through the gas outlet 54 into the cooling device 56 condenses within the cooling device 56. A condensate line 66 is connected to the base 62 of the cooling device 56 via a condensate pump 64 and opens into a collection container 68 for condensate.

Furthermore, an injector 70 is provided between the cooling device 56 and the air outlet 58, said injector 70 having a regulable pressure reducer and being connected to a compressed air supply 72. Vapor within the processing container 10 can hereby be conveyed out of it with an increased air flow, as will be described in more detail below.

The cover 12 shown in the FIGURE can be moved up and down in the vertical direction along the arrows shown above the cover 12 by a lifting device, not shown in more detail, to introduce components B to be smoothed into the interior of the processing container 10. For this purpose, in the embodiment shown, a holder 74 is provided at the lower side of the cover 12, to which holder 74 the components B can be fastened and which can be raised and lowered vertically in the direction of the arrows shown by means of a lifting device 75 to be able to immerse the components B within the processing container 10 in process liquid P or remove them therefrom.

The system described above can also be designed with a plurality of separate containers to spatially separate the individual process steps (heating, smoothing, cooling, dyeing, rinsing, etc.) from one another and to be able to perform them in an optimized cycle time in an industrial process. In the case of the smoothing process in the system described and the process liquids listed, the components can pass through a plurality of process steps, i.e. the components are heated by the process liquid, are chemically smoothed, are possibly simultaneously died by additionally inserted dyes, are cooled by air or a cooler process liquid to end the smoothing process and/or to cool the components or to rinse the components following the treatment with the process liquid, for example with water and possibly with suitable additives such as acid, alkali, salts, organic additives such as surfactants or alcohols, etc., and/or to cool them at the same time. These process steps can be performed without the rinsing process in a work container. In a more advanced embodiment, it is, however, also possible for the treatment of the components with the method in accordance with the invention to be performed in a system in which the execution of the process steps is divided among a plurality of work containers.

A method for the chemical smoothing of components B using the above-described apparatus is described below.

At the start of the smoothing process, all of the process liquid P is located within the temperature control container 14 and the cover 12 is raised so far that components B to be smoothed that are made of a polymer material can be fastened to the holder 74 at the lower side of the cover 12. By lowering the cover 12, it can then be placed on the processing container 10 so that the latter is closed in an airtight manner at its upper side.

With closed valves 36 and 52 and open valves 24 and 48, the heating device 27 and the pump 22 are subsequently activated, whereby the process liquid P within the temperature control container 14 is pre-temperature-controlled and is in this respect simultaneously circulated through the pipeline 16, the processing container 10 and the pipeline 18. The conveying performance of the pump 22 is in this respect selected such that the process liquid within the processing container 10 does not exceed the filling level F1, but rather the entire process liquid flows through the aperture 44 into the pipeline 18 and can thereby be uniformly heated and circulated without any appreciable temperature gradient.

After a predetermined time period or after a desired temperature has been reached, the process liquid P has been heated to such an extent that vapor forms above the fluid surface and can preheat the components B within the processing container 10. However, at all times there is communication between the interior of the processing container 10 and the surrounding atmosphere, namely via the gas outlet 54, the cooling device 56 and the air outlet 58.

After the components B have reached a desired preheating temperature, the valve 24 can be closed so that the processing container 10 fills up to the filling level F2 with heated process liquid P. The components B are hereby immersed in the process liquid P. Excess process liquid and also vapor within the processing container 10 can be returned to the temperature control container 14 via the overflow line 46, the inlet 20 and the filter 31. After a certain time period, for example after a few minutes, the actual smoothing process is ended so that the pump 22 can be switched off completely and the valve 24 can be opened, whereby the process liquid P flows back into the temperature control container 14 whose heating device 27 is then deactivated.

Any vapor that develops above the fluid surface during the smoothing process can exit via the gas outlet 54 into the cooling device 56 and condense there so that the condensate produced can be conveyed by the condensate pump 64 into the condensate line 66 and from there into the condensate container 68. The air then exiting through the air outlet 58 is thereby freed of process vapor.

To subsequently cool the components B within the processing container 10, the valve 52 of the air inlet 50 can be opened and compressed air can be introduced into the injector 70 via the compressed air supply 72 and then flows out through the air outlet 58. The flow rate is hereby increased and environmental air is drawn in through the air inlet 50. Said environmental air flows through the processing container 10 and thereby cools the components B. At the same time, the interior of the processing container 10 is completely emptied of vapor that is generated by the preceding smoothing process.

When the interior of the processing container 10 has cooled to a desired temperature, which can for example be detected by the temperature probe 33, the components B also have a temperature that allows a removal. The cover 12 can then be raised again so that the components B can be removed from the holder 74.

It is understood that the workflow described above can be fully controlled and managed by the control (not shown), wherein the temperature sensors described at the beginning can also be in communication with the control to determine the temperature of the components. Material-specific and component-specific treatment programs with parameters for the component treatment can also be stored in the control. Thus, the following parameters and actions can be stored in the control: Treatment times, e.g. for heating the components in the gas phase, for the spraying on or the brief or complete immersion, the application time of the process liquid to the surface or to part regions of the surface at different temperatures, the temperature in the gas phase and the process liquid, the cooling with air, by spraying on a cooler process liquid or by immersion, associated actions of the (partly) automated system components such as the lifting and lowering apparatus, the valves, temperature control devices, pumps and blowers. The glycols or glycol mixtures described in this application are particularly suitable as process liquids.

After the smoothing process, the components can still be subjected to a rinsing process to ensure consistent quality.

The control can be configured as a local or global control, possibly with a digital interface for integration into a process chain with a data transfer, to enable further optimizations and evaluations, e.g. via algorithms, machine data acquisition systems or production control systems.

1-24. (canceled)

25. A method for the chemical smoothing of components composed of a polymer material, comprising the following steps:
providing a pre-temperature-controlled process liquid,
applying process liquid to the components over a time period, and
removing the process liquid from the components,
wherein the method is performed at atmospheric pressure, and
wherein at least 50% by volume of the process liquid consists of glycol or a mixture of glycols.

26. The method according to claim 25,
wherein the process liquid is pre-temperature-controlled to a temperature of 150° C. to 190° C.

27. The method according to claim 25,
wherein process liquid is applied to the components over a time period of less than 20 minutes.

28. The method according to claim 25,
wherein the components are immersed multiple times and removed from the process liquid again.

29. The method according to claim 25,
wherein process liquid is sprayed onto the components.

30. The method according to claim 25,
wherein the process fluid comprises a mixture of at least two glycols.

31. The method according to claim 30,
wherein the mixture comprises polyethylene glycol and triethylene glycol.

32. The method according to claim 30,
wherein the mixture comprises two glycols in a mixing ratio of 5:1 to 1:5.

33. The method according to claim 25,
wherein the process liquid includes salts and/or mineral acids in a proportion of less than 2% by volume.

34. The method according to claim 25,
wherein the process liquid consists of at least 75% by volume of glycol or a mixture of glycols.

35. The method according to claim 25,
wherein the process liquid comprises a dissolved or dispersed dye.

36. The method according to claim 25,
wherein the polymer material is based on a polymer based on at least one monomer having at least one heteroatom, or wherein
the polymer material is based on polyamide, polyester or polyether ether ketone.

37. The method according to claim 36,
wherein the polyamide is selected from the group consisting of PA 6, PA 11, PA 12, PA 6.6, PA 6.9, PA 6.12, PA 4.6, PA 12.12, or wherein the polyester is selected from the group consisting of PBT, PET, PLA, PTT, PEN, PC, PEC and PAR.

38. The method according to claim 25,
wherein the temperature of a component is detected during the method and used as a control parameter.

39. The method according to claim 25,
wherein a temperature sensor is attached to one of the components prior to the application of process liquid.

40. The method according to claim 25,
wherein the application of process liquid takes place in a processing container that can be closed in an airtight manner by a cover.

41. The method according to claim 25,
wherein the process liquid is pre-temperature-controlled in a temperature control container by heating or cooling and is transferred to a processing container in which the process liquid is applied to the components.

42. The method according to claim 25,
wherein the process liquid is conducted in a circuit between the temperature control container and the processing container.

43. The method according to claim 25,
wherein the components are cooled in the processing container after the removal of the process liquid.

44. An apparatus for performing a method for the chemical smoothing of components composed of a polymer material, comprising a processing container and a temperature control container for the temperature control of the process liquid, wherein the two containers are connected to one another via a liquid circuit in which a pump is located, the method comprising the following steps:
providing a pre-temperature-controlled process liquid,
applying process liquid to the components over a time period, and
removing the process liquid from the components,
wherein the method is performed at atmospheric pressure, and
wherein at least 50% by volume of the process liquid consists of glycol or a mixture of glycols.

45. The apparatus according to claim 44,
wherein the gas outlet opens into a cooling device that is in communication with the atmosphere.

46. The apparatus according to claim 44,
wherein the cover has a holder for components to be smoothed.

47. The apparatus according to claim 46,
wherein at least one lifting device is provided by which the cover can be moved relative to the processing container and/or the holder can be moved relative to the cover.

48. A component that has been smoothed by a method according to claim 25.
